(19) United States
(12) Patent Application Publication
(10) Pub. No.: US 2024/0116257 A1
(43) Pub. Date: Apr. 11, 2024

(54) TIRE REPAIR MACHINE AND A METHOD OF REPAIRING A TIRE

(71) Applicant: NBTechnologies Inc., St. Albert (CA)

(72) Inventors: Jordan MARUSCHAK, St. Albert (CA); Levi McCarroll, Camrose (CA)

(73) Assignee: NBTechnologies Inc., St. Albert (CA)

(21) Appl. No.: 18/475,824

(22) Filed: Sep. 27, 2023

Related U.S. Application Data
(60) Provisional application No. 63/414,253, filed on Oct. 7, 2022.

(51) Int. Cl. B29C 73/16; B29C 73/28; B60C 25/00

(52) U.S. Cl. CPC B29C 73/166; B29C 73/28; B60C 25/16; B29L 2030/00

(57) ABSTRACT

A tire repair machine has a base with a tire support, a clamp, and an injector. The clamp is releasably holds a tire for repair on the tire support. The injector is movable relative to the base and forces melted compound into a repair zone of the tire for repair. There is also provided a method of repairing a tire that utilizes a tire repair machine. A tire is clamped in the tire support of the base. The repair zone is drilled to clear the area to be repaired. A melted compound is injected into the repair zone of the tire. Once repaired, the tire is released from the clamp and tire support of the base.

### FIELD OF THE DISCLOSURE

The present application relates generally to a tire repair machine, and more specifically related to an automated tire repair machine.

### BACKGROUND

This section provides background information to facilitate a better understanding of the various aspects of the invention. It should be understood that the statements in this section of this document are to be read in this light, and not as admissions of prior art.

Tire repair or patching following a puncture requires a number of steps that are presently completed manually by a technician at tire shops. This process involves manually preparing the inside of the tire for a patch by scraping away the mold release from the inside of a tire and roughing up the area for application of a tire plug patch or other patch. Generally, glue is then added to the inside of the tire before the patch is applied and bonded to the tire. Following the bonding process, the tire must be left long enough to allow the patch to properly adhere to the tire. This is a labor-intensive and time consuming process. It can also cause stress injuries to those undertaking the repair.

### BRIEF SUMMARY

There is provided a tire repair machine that has a base, a clamp, and an injector. The base has a tire support where a tire to be repaired is held. The clamp releasably holds the tire for repair on the tire support. The injector is movable relative to the base and forces melted compound into a repair zone of the tire for repair.

In one embodiment, the tire repair machine has a control panel with a programmable logic controller or integrated circuit board. The control panel provides at least one operational control. The operational control can include a start/stop button and may also include inputs for other commands including positioning of the injector and the injection of melted compound into the repair zone of the tire for repair. A power source is providing for powering the control panel and other parts of tire repair machine.

In one embodiment, the clamp is controlled by the control panel such that it can be extended, contracted, or moved as desired.

In one embodiment, at least one sensor provides information about tire dimension. Sensors may also be provided that provide information on other tire features.

In one embodiment, the control panel is in electrical communication with the at least one sensor. Information is received by the control panel from the at least one sensors and is used to determine a center of the tire and a volume of melted compound to be applied for repair purposes.

In one embodiment, at least one drill is provided for drilling out the repair zone of the tire for repair prior to the injector forcing melted compound into the repair zone of the tire for repair. The at least one drill may be supported on a support frame.

In one embodiment, a hopper is provided for supplying compound to the injector.

In one embodiment, the injector is a heated injector that melts compound prior to forcing melted compound into the repair zone of the tire repair.

In one embodiment, the clamp is movable into a position in alignment with the injector such that it acts as a barrier to prevent melted compound from escaping from one side of the repair zone of the tire for repair.

There is also provided a method for repairing a tire. The method includes providing a tire repair machine that has a base with a tire support, a clamp for releasably holding a tire for repair on the tire support, and an injector that is movable relative to the base that forces melted compound into a repair zone of the tire. A tire is clamped in the tire support of the base, the repair zone is drilled out to provide a clean repair surface, and melted compound is injected into the repair zone of the tire. After injection of the melted compound, the tire is released from the clamp and tire support of the base.

In one embodiment, the tire repair machine has a control panel with a programmable logic controller or integrated circuit board. The control panel provides at least one operational control for operating the tire repair machine. The operational control can include a start/stop button and may also include inputs for other commands including positioning of the injector and the injection of melted compound into the repair zone of the tire for repair. A power source is provided for powering the control panel and other parts of tire repair machine.

In one embodiment, movement of the clamp is controlled by the control panel such that it can be extended, contracted, or moved as desired.

In one embodiment, the tire repair machine has at least one sensor that provides information about tire dimension. The tire repair machine utilizes the information regarding tire height and tire width to automate movement of the clamp. Sensors may also be provided that provide information on other tire features.

In one embodiment, the control panel determines a center of the tire and a volume of melted compound to be applied for repair purposes based upon the information provided by the at least one sensor.

In one embodiment, at least one drill is provided for drilling out the repair zone of the tire for repair prior to the injector forcing melted compound into the repair zone of the tire for repair. The at least one drill is position on a support frame.

In one embodiment, a hopper is provided for supplying compound to the injector.

In one embodiment, the injector is a heated injector that melts compound prior to forcing melted compound into the repair zone of the tire repair.

In one embodiment, the clamp is movable into a position in alignment with the injector such that it acts as a barrier to prevent melted compound from escaping from one side of the repair zone of the tire for repair.

In one embodiment, the tire repair machine has at least one drill for drilling out the repair zone. The at least one drill is the at least one drill being supported on a support frame. The at least one drill is positioned and operated by the control panel.

In one embodiment, the tire repair machine has a hopper for supplying compound to the injector.

In one embodiment, the injector of the tire repair machine is a heated injector that melts compound prior to forcing melted compound into the repair zone.

In one embodiment, the clamp is movable into a position in alignment with the injector such that it acts as a barrier to prevent melted compound from escaping from one side of the repair zone of the tire for repair.

In one embodiment, the clamp is positioned adjacent the repair zone during use of the at least one drill and is movable to be in alignment with the injector prior to injection of the melted compound such that the clamp acts as a barrier to prevent melted compound from escaping from one side of the repair zone of the tire for repair.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a tire repair machine.

FIG. 2 is a perspective view of the tire repair machine with a tire positioned on the tire support.

FIG. 3 is a top plan view of the tire repair machine with a tire positioned on the tire support and the clamp contracted.

FIG. 4 is a top plan view of the tire repair machine with a tire positioned on the tire support and the clamp extended to hold the tire in position.

FIG. 5 is a side elevation view, in section, of the tire repair machine with a tire clamped in the tire support and the tire being drilled.

FIG. 6 is a side elevation view, in section, of the tire repair machine with a tire clamped in the tire support and the injector injecting melted compound.

FIG. 7 is a schematic view of electronics associated with the tire repair machine.

### DETAILED DESCRIPTION OF THE PREFERRED EMBODIMENTS

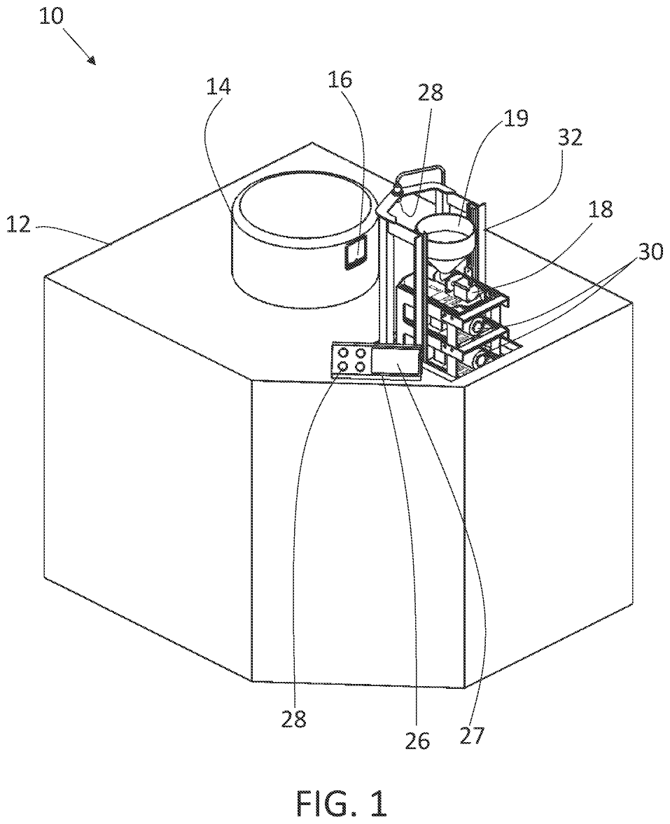

A tire repair machine, generally identified by reference numeral 10, will now be described with reference to FIG. 1 through FIG. 7.

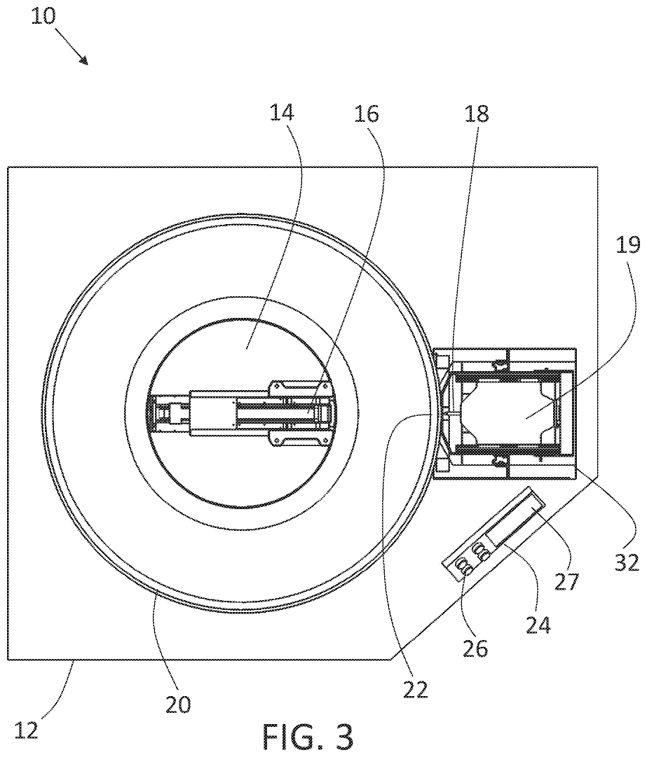

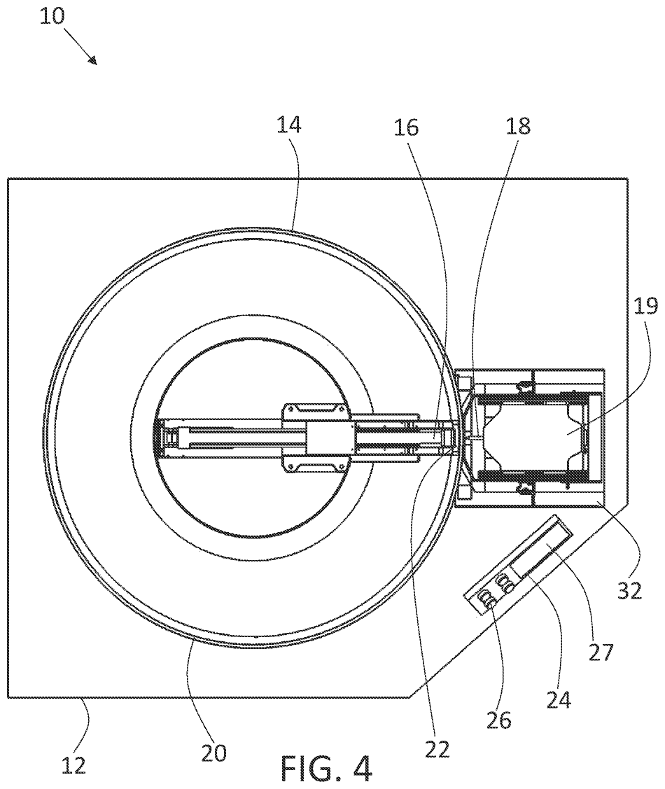

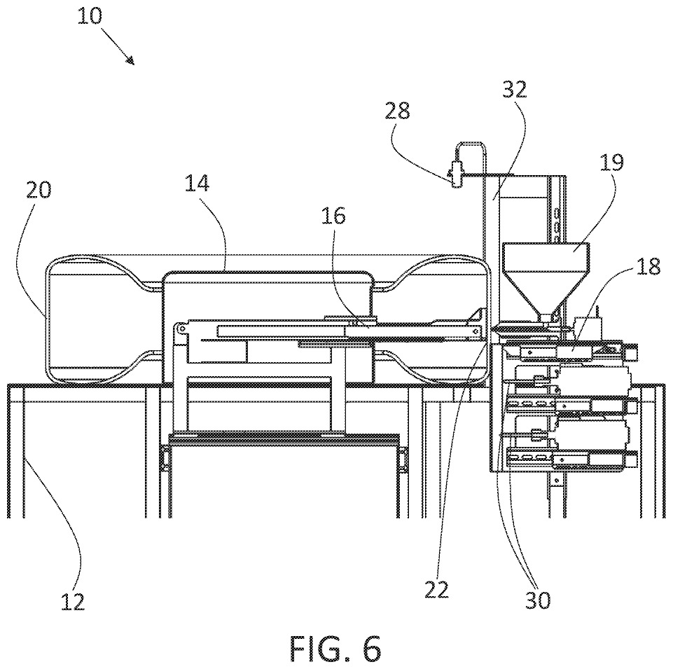

Referring to FIG. 1, tire repair machine 10 has a base 12 with a tire support 14, a clamp 16, and an injector 18. Referring to FIG. 4, clamp 16 releasably holds a tire for repair 20 on tire support 14. In the embodiment shown, clamp 16 is positioned such that it extends outwards from tire support 14, shown in FIG. 4, and contracts within tire support 14, shown in FIG. 3, when not engaging tire for repair 20. It will be understood by a person skilled in the art that positioning the clamp in other locations is also possible. Referring to FIG. 6, injector 18 is movable relative to base 12 and is used to force melted compound, under pressure, into a repair zone 22 of tire for repair 20. Melted compound may be a melted rubber, melted rubber composites such as polymers, or any other suitable melted compound known to a person skilled in the art. Melted compound may cool quickly which allows tire repair to be completed quickly. A hopper 19 may be provided that supplies compound to injector 18. Injector 18 may be a heated injector that heats compound such that it melts before forcing melted compound into repair zone 22. When a heated injector is used, hopper 19 may supply solid compound that is melted within heated injector. It will be understood by a person skilled in the art that hopper 19 could also act as a funnel to funnel pre-melted compound into injector 18 for use. It will further be understood that injector may be supplied with solid or melted compound by any other means known to a person of skill in the art. In the embodiment shown, injector 18 utilizes a motor to turn a screw inside a barrel and is similar to the injectors used in plastic and rubber injection molding machines. It will be understood by a person skilled in the art that a piston with plunger, or any other suitable injector capable of injecting melted compound into repair zone 22 may be used.

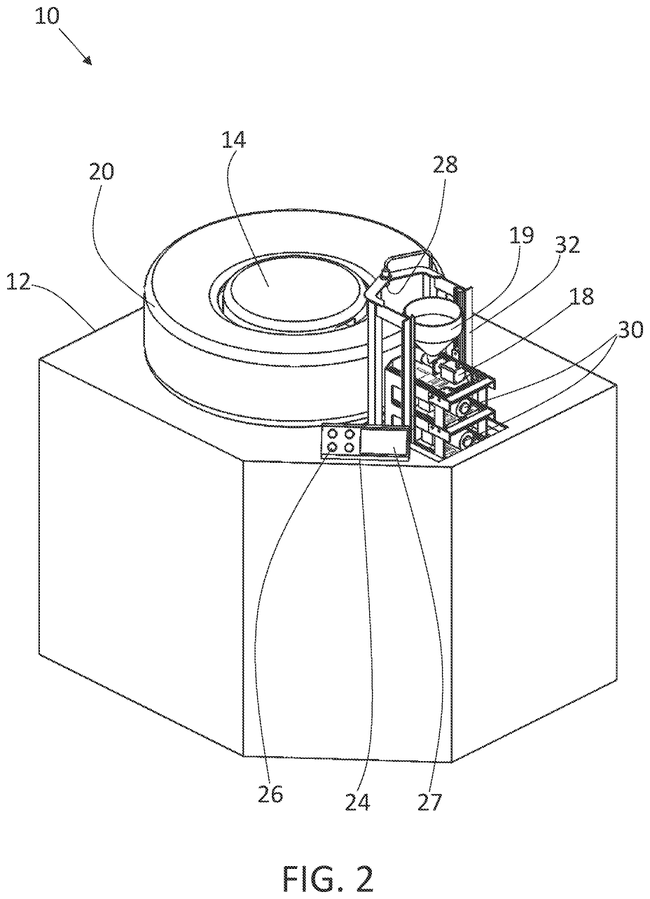

Referring to FIG. 2, tire repair machine 10 may be automated, or partially automated, through the use of a control panel 24. Control panel 24 may allow for automation of the entire tire repair process or may be used to guide an operator through the process step by step. In the embodiment shown, control panel 24 has a start/stop button 26. Start/stop button may be used to initiate the repair process, a step in the repair process, and initiate an emergency stop if needed. Control panel 24 includes a programmable logic controller (PLC) or integrated circuit board that contains programmed logic that allow control panel 24 to interact with all elements of tire repair machine 10, including but not limited to sensors, control electronics, mechanical elements, power supplies, motors, heated injector 18, and any additional heaters, such as might be found to heat compound in hopper 19 if desired. As a part of PLC or integrated circuit board with programmed logic, control panel 24 may have a database of tires, including brands, sizes, tread patterns, and additional information that control panel 24 uses to analyze data and control tire repair machine 10. In the embodiment shown, control panel 24 has a touch screen 27 that provides information to the user and allows inputs into control panel 24. It will be understood by a person skilled in the art that control panel 24 may be in wired or wireless communication with other elements of tire repair machine 10. Control panel 24 may provide updates, notifications, and warnings to user prior to, during, and after use.

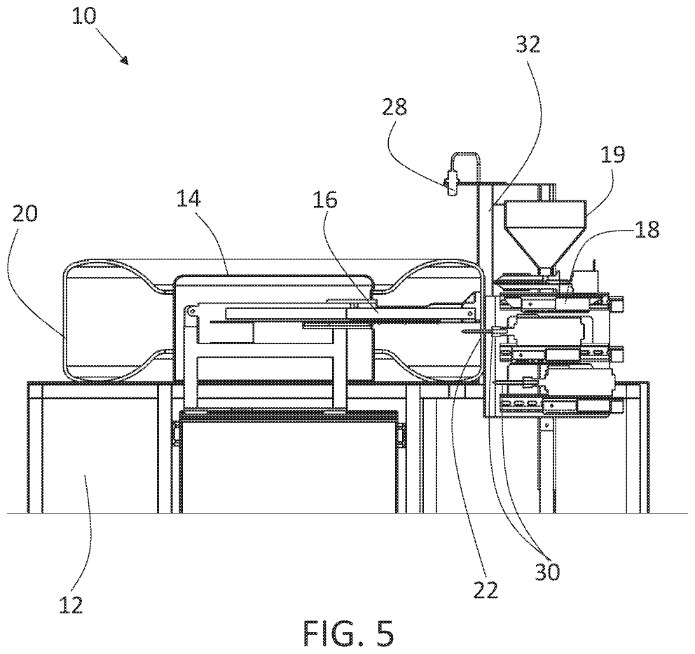

Referring to FIG. 5 and FIG. 6, a sensor 28 is positioned such that information regarding tire dimension can be sensed, this may include tire height, tire width, tire height and tire width, or any other useful dimension. In the embodiment shown, a single sensor 28 is used, however it will be understood by a person skilled in the art that multiple sensors may be used and that the positioning may be different. It will also be understood that different types of sensors may be used to determine height and tire width. For example, an ultrasonic sensor, a proximity sensor, a weight sensor, a digital measuring tape, or any other suitable sensor where data can be used to determine height and width are useable. Other sensors may also be used within tire repair machine 10, including electrical current sensors for detecting when clamp 16 and injector 18 make contact with tire for repair 20. Control panel 24 is in electrical communication with sensor 28 such that information from sensor 28 is received by control panel 24. Control panel 24 uses the information to determine a center of the tire and a volume of melted compound to be applied. Determining a center of tire for repair 20 is a simple calculation that requires dividing the height of the tire by two. Determining a center of tire for repair 20 allows control panel 24 to limit movement of clamp 16 as needed to prevent damage to the tire bead. Alternatively, information from sensor 28 may be compared to known tire sizes and brands in a database to determine where clamp 16 can be safely extended while avoiding the tire bead. The volume of melted compound to be applied is dependent upon the size of repair zone 22 and width of tire for repair 20.

Referring to FIG. 5, a drill 30 is provided for drilling out repair zone 22 of tire for repair 20 prior to injector 18 forcing melted compound into repair zone 22. It will be understood by a person skilled in the art that drilling out repair zone 22 of tire for repair 20 could occur prior to tire for repair 20 being placed on tire support 14 or could be manually drilled while tire for repair 20 is on tire support 14. In a preferred embodiment, drill 30 is controlled by control panel with control panel 24 controlling positioning and use of drill 30. In the embodiment shown in FIG. 5, two drills 30 are positioned on a support frame 32. Support frame 32 may be movable with control panel 24. It will be understood by a person skilled in the art that a single drill 30 or multiple drills 30 may be provided for use. A potential benefit of having multiple drills 30 is that different sizes may be used depending upon the size of repair zone 22 without the need to change drill bits when only a single drill 30 is provided. In the embodiments shown, injector 18 and hopper 19 are also positioned on support frame 32. It will be understood by a person skilled in the art that injector may be on the same support frame 32 as drills 30, a different support frame, or be independent of support frames.

Clamp 16 may be positioned in different locations on interior of tire for repair 20 depending upon the step being taken. Referring to FIG. 5, during drilling clamp 16 may be positioned adjacent repair zone 22 such that clamp 16 is out of the way of drill 30 during use. This helps to prevent damage to clamp 16 while ensuring that repair zone 22 is drilled out completely. In the embodiment shown, clamp 16 is positioned above repair zone 22, however it will be understood by a person skilled in the art that clamp 16 could be positioned below, to the side, or in any other suitable location adjacent repair zone 22. Referring to FIG. 6, prior to injecting melted compound into repair zone 22, clamp 16 may be moved into alignment with injector 18 such that it acts as a barrier to prevent melted compound from escaping from one side of repair zone 22. This helps to ensure that melted compound is squeezed into any irregularities within repair zone 22. Movement of clamp 16 may be controlled by control panel 24. Clamp movement may be automated or control panel 24 may be set up to allow a user to manipulate movement of clamp 16 with a joystick, buttons, or other controlling means.

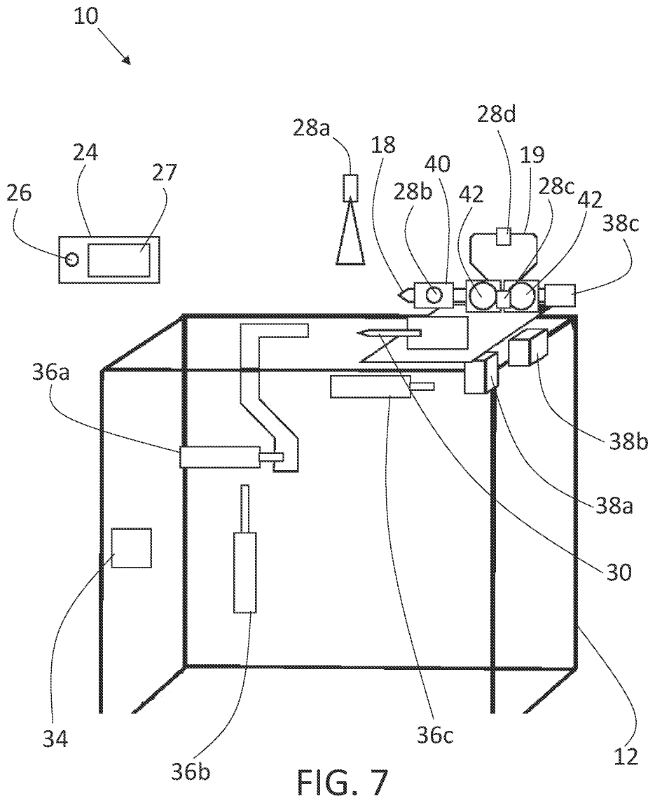

Referring to FIG. 7, tire repair machine 10 utilizes sensors, control electronics, mechanical elements, power supplies, motors, and heaters which are in electrical communication with control panel 24. In the embodiment shown, a main power connection 34 is provided that provides power to tire repair machine 10 and tire repair machine components. In the embodiment shown, main power connection 34 is an AC connection, however it will be understood by a person skilled in the art that main power connection 34 may connect to any suitable power source. It will further be understood by a person of skill in the art that multiple power sources may be used. Actuators are provided for moving clamp 16. Actuator 36a moves clamp from a contracted position, shown in FIG. 3, to an extended position, shown in FIG. 4. Actuator 36b moves clamp up and down relative to base 12. Actuator 36c may be used to move support frame 32 to position drills 30 and injector 18 as needed for repair. It will be understood by a person skilled in the art that additional actuators or different movement devices may be used to allow for movement of clamp, drills, and injector. Motors 38a and 38b may be used to operate drills 30 and motor 38c may be used to operate injector 18. A heater 40 is provided for heating injector 18, which causes compound to melt prior to injection into repair zone 22. Fans 42 may be provided for cooling injector 18 to prevent overheating of injector 18. Tire repair machine 10 may utilize a number of different sensors. In the embodiment shown, an ultrasonic sensor 28a is provided for determining the height of tire for repair 20. Injector 18 may have a temperature sensor 28b which is used to help ensure that melted compound remains at the correct temperature for injector. In the present embodiment, hopper 19 has a temperature sensor 28c that provides notification in the event that hopper 19 becomes too hot and a limit switch 28d this is used to determine when hopper 19 needs to be refilled with compound. Control panel 24 may provide a warning related to signals from any of sensors 28a, 28b, 28c, or 28d. While not shown, it would be understood by a person skilled in the art that other sensors could be beneficial, including but not limited to alignment lasers that could aid in locating puncture holes. In addition, electrical current sensors, not shown, can be provided to detect the electrical current draw from actuators which allows control panel 24 to determine when clamp 16, drill 30, or injector 18 have made contact with tire for repair 20. Actuators may also have sensors that provide information to control panel 24 about the location of actuators such that current physical location of elements are known and correct movement instructions may be provided as needed.

Tire repair machine 10 has a number of advantages over conventional tire patching methods. Tire repair machine 10 holds tire for repair 20 during the tire repair process in a safe way that prevents injury to personnel and unwanted damage to tire for repair 20 that can occur if improperly held by industrial clamps, bench clamps, G or C clamps, or any other clamp known to a person skilled in the art. Unwanted damage to tire for repair 20 can include damage to the tire bead. Tire repair machine 10 uses a melted compound to repair a puncture and does not rely on glue or other adhesives which take time to cure and properly adhere to a tire. When control panel 24 is set up for full automation, the entire tire repair process may be automated which can help to prevent human error during the repair process and inconsistent quality repairs. Tire repair machine 10 is able to handle multiple sizes of tires, multiple puncture sizes, various diameter tires, and different tread styles of tires.

Use of tire repairing machine 10 will be described with reference to the embodiments shown. It will be understood by a person skilled in the art that not all steps may need to be performed in every instance and that some steps, such as drilling, may occur manually before tire for repair 20 is positioned on tire support 14, manually after tire for repair 20 is positioned on tire support 14, or through automated means controlled by control panel 24 when drills 30 are provided on support frame 32. Referring to FIG. 2, repair zone 22 of tire for repair 20 is marked with a visual marker such as a grease pen, paint, or any other suitable marker. Tire for repair 20 is then positioned on tire support 14 such that repair zone 22 is positioned towards injector 18. When laser guidance is provided, user will position tire for repair 20 such that repair zone 22 is positioned in alignment with laser guidance to place tire for repair 20 in the correct starting location. This is completed by rotating the tire on tire support 14, either manually or through mechanized means, and using positioning controllers present on control panel 24 as needed to move either tire support 14 up and down or support frame 32 up and down.

Once tire for repair 20 is in position, start/stop button 26 is activated to start the repair process. Once activated, sensor 28 collects information regarding tire dimensions, including height of tire for repair 20. Tire dimension information is provided to control panel 24 which calculates a center of tire for repair 20. The center of tire for repair 20 is used to guide clamp 16 through the relatively narrow opening on the inside of tire for repair 20. Movement of clamp 16 is stopped when current sensors detect that clamp 16 has made contact with an interior surface of tire for repair 20. Once clamp 16 is in place, information regarding the positioning of clamp 16 is provided to control panel which allows for the calculation of the amount of compound required for repair. This information is also used to determine tire thickness to control the depth of drilling by drill 30. As can be seen in FIG. 5, when drilling using drill 30 occurs, clamp 16 is positioned adjacent repair zone 22 such that clamp 16 does not come into contact with drill 30. The speed of drill 30 may be controlled by control panel 24 such that a constant RPM is achieved that is fast enough to drill properly without burning tire for repair 20. Generally, as drilling occurs, power will increase to drill 30 to maintain appropriate RPM. Once repair zone 22 has been drilled out, drill 30 may be moved in and out of hole to clean out the hole.

Following drilling, control panel 24 causes clamp 16 to move into alignment with injector 18 and repair zone 22. Injector 18 is moved into contact with tire for repair 20 such that melted compound is injected into repair zone 22. Melted compound is prevented from escaping repair zone 22 by clamp 16 and injector 18. Following injection of melted compound into repair zone 22, injector 18 and clamp 16 remain in position for a predetermined amount of time to allow for compound to cool and solidify. The predetermined amount of time is generally under 10 seconds; however, it will be understood by a person skilled in the art that the amount of time may vary depending upon the specific composition of the melted compound. Injector 18 and clamp 16 are then moved away from tire 20 and control panel 24 notifies the user that tire 20 may be removed from tire support 14.

It will be understood by a person skilled in the art that control panel 24 may be programmed to control the repair process in its entirety once tire for repair 20 has been placed on tire support 14. Different sensors, different actuators, and different motors may be used. Programming to illicit specific movements and actions is well known to a person skilled in the art.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A tire repair machine, comprising:
a base, the base having a tire support;
a clamp for releasably holding a tire for repair on the tire support; and
an injector, the injector being movable relative to the base, the injector forcing melted compound into a repair zone of the tire for repair.

2. The tire repair machine of claim 1 further comprising a control panel and a power source, the control panel having a programmable logic controller or integrated circuit board, the control panel providing at least one operational control, the power source providing power to the tire repair machine.

3. The tire repair machine of claim 2 wherein the at least one operational control includes a start/stop button.

4. The tire repair machine of claim 2 wherein movement of the clamp is controlled by the control panel.

5. The tire repair machine of claim 2 further comprising at least one sensor, the at least one sensor providing information regarding tire dimension.

6. The tire repair machine of claim 5 wherein the control panel is in electrical communication with the at least one sensor, the control panel receiving information from the at least one sensor for determining a center of the tire and a volume of melted compound to be applied.

7. The tire repair machine of claim 2 further comprising at least one drill for drilling out the repair zone of the tire for repair prior to the injector forcing melted compound into the repair zone of the tire for repair, the at least one drill being supported on a support frame.

8. The tire repair machine of claim 1 further comprising a hopper for supplying compound to the injector.

9. The tire repair machine of claim 1 wherein the injector is a heated injector that melts compound prior to forcing melted compound into the repair zone of the tire for repair.

10. The tire repair machine of claim 1 wherein the clamp is movable into a position in alignment with the injector such that it acts as a barrier to prevent melted compound from escaping from one side of the repair zone of the tire for repair.

11. A method of repairing a tire, comprising the steps of:
providing a tire repair machine comprising:
a base, the base having a tire support;
a clamp for releasably holding a tire for repair on the tire support; and
an injector, the injector being movable relative to the base, the injector forcing melted compound into a repair zone of the tire;
clamping the tire to be repaired in the tire support of the base;
drilling to clean out a repair zone;
injecting a melted compound into the repair zone of the tire;
releasing the tire from the clamp and tire support of the base.

12. The method of repairing a tire of claim 11 wherein the tire repair machine further comprises a control panel and a power source, the control panel having a programmable logic controller or integrated circuit board, the control panel providing at least one operational control for operating the tire repair machine, the power source providing power to the tire repair machine.

13. The method of repairing a tire of claim 12 wherein movement of the clamp is controlled by the control panel.

14. The method of repairing a tire of claim 12 wherein the tire repair machine further comprises at least one sensor, the at least one sensor providing information regarding tire dimension, the tire repair machine utilizing the information regarding tire height and tire width to automate movement of the clamp.

15. The method of repairing a tire of claim 14 wherein the control panel determines a center of the tire and a volume of melted compound into the repair zone of the tire for repair based upon the information provided by the at least one sensor.

16. The method of repairing a tire of claim 12 wherein the tire repair machine further comprises at least one drill for drilling out the repair zone, the at least one drill being supported on a support frame, the at least one drill being positioned and operated by the control panel.

17. The method of repairing a tire of claim 11 wherein the tire repair machine further comprises a hopper for supplying compound to the injector.

18. The method of repairing a tire of claim 11 wherein the injector is a heated injector that melts compound prior to forcing melted compound into the repair zone.

19. The method of repairing a tire of claim 12 wherein the clamp is movable into a position in alignment with the injector such that it acts as a barrier to prevent melted compound from escaping from one side of the repair zone of the tire for repair.

20. The method of repairing a tire of claim 16 wherein the clamp is positioned adjacent the repair zone during use of the at least one drill and is movable to be in alignment with the injector prior to injection of the melted compound such that the clamp acts as a barrier to prevent melted compound from escaping from one side of the repair zone of the tire for repair.
